(19) United States
(12) Patent Application Publication
(10) Pub. No.: US 2006/0001957 A1
(43) Pub. Date: Jan. 5, 2006

(54) Display device and image processing method therefor

(75) Inventor: Nai-Yueh Liang, Taipei City (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 10/983,660

(22) Filed: Nov. 9, 2004

(30) Foreign Application Priority Data
Jul. 5, 2004 (TW) 093120159

(51) Int. Cl. G02B 23/14

(52) U.S. Cl. 359/432

(57) ABSTRACT

A display device includes an image-gaining processing module, a light source, a color-filtering module, a modulating module and an imager. The image-gaining processing module, which receives an image signal and filters out a first color image signal and a second color image signal, generates a first color gain value depend on the first color image signal and generates a second color gain value depend on the second color image signal. The image-gaining processing module generates a first color image-gaining signal and a second color image-gaining signal. The color-filtering module filters a first color light beam at a first time slot and filters a second color light beam at a second time slot. The modulating module generates a first color control signal and a second color control signal. The imager receives the first color image-gaining signal at the first time slot, and the second color image-gaining signal at the second time slot.

### BACKGROUND OF THE INVENTION

1. Field of Invention

The invention relates to a display device and image processing method therefor and, in particular, to a display device and image processing method therefor with a large dynamic range.

2. Related Art

With the arrival of a multimedia era, the use of display devices, such as a CRT display, a LCD display, a plasma display, an electroluminescent display and a projection display, has become popular more and more in every field.

The image projecting systems can be divided into different types, such as CRT projector, LCD projector and DLP projector. The LCD projector and the DLP projector have come into widespread use because they are suitable for high luminance and high display quality.

However, the dynamic range of the LCD projector and the DLP projector is not large. For instance, the actual dynamic range of a LCD projector is about 300-400:1, and the actual dynamic range of a DLP projector is about 500-600:1 (here, a device has a large dynamic range means that it is able to display an image with high contrast and many-levels of gradation). If the dynamic range of a display device is not large enough, a user cannot differentiate images if the brightness of the images is darker (such as night images).

To solve this problem, U.S. Pat. No. 6,683,657 disclosed a projection display system 1, in which an illumination-light amount modulating means is provided to adjust the light amount illuminated to an optical modulator. As shown in FIG. 1, the light illuminated from a light source 11 is reflected by a reflector 12 and becomes a parallel light beam. After passing an integrator 13, the parallel light beam enters a PS converter 14, and is converted from a non-polarized light beam to a linearly-polarized light beam.

The linearly-polarized light beam then enters the optical device 15 having a rotatable polarizing plate. Afterwards the light beam illuminates to the LCD panel 18 via a plurality of reflection layers 16 and prisms 17. The LCD panel 18 controls the light beam to form an image. The polarizing plate is driven by a motor (not shown in the drawing). Since the polarizing plate rotates continuously, the amount of light entering the LCD panel 18 changes accordingly. The amount of light entering the LCD panel 18 is determined according to the input image signal, and the rotation angle of the polarizing plate, which correspondents to the rotation angle of the motor, is calculated in view of the amount of light.

However, the image projecting system mentioned above has an additional illumination-light amount modulating means, which makes the system heavier and larger, and thus not suitable for a compact projection system. Moreover, the angle of the polarizing plate is adjusted mechanically via a motor, which limits the precision of angle adjustment.

### SUMMARY OF THE INVENTION

In view of the above-mentioned problems, the invention is to provide a display device and an image processing method therefor with an increased dynamic range.

To achieve the above, in one embodiment of the invention, the display device includes an image-gaining processing module, a light source, a color-filtering module, a modulating module and an imager. The image-gaining processing module, which receives an image signal and filters out a first color image signal and a second color image signal from the image signal, generates a first color gain value depend on the first color image signal and generates a second color gain value depend on the second color image signal. The image-gaining processing module generates a first color image-gaining signal according to the first color gain value and the first color image signal and generates a second color image-gaining signal according to the second color gain value and the second color image signal. The light source emits a light beam. The color-filtering module filters a first color light beam from the light beam at a first time slot and filters a second color light beam from the light beam at a second time slot. The modulating module is electrically connected with the light source and the image-gaining processing module, wherein the modulating module generates a first color control signal according to the first color gain value to control the brightness of the light beam from the light source to become a multiple of the original brightness of the light beam from the light source and the inverse of the first color gain value, and generates a second color control signal according to the second color gain value to control the brightness of the light beam from the light source to become a multiple of the original brightness of the light beam from the light source and the inverse of the second color gain value. The imager is electrically connected with the image-gaining processing module, wherein the imager receives the first color image-gaining signal at the first time slot and produces an first color image using the controlled light beam from the light source, and the imager receives the second color image-gaining signal at the second time slot and produces an second color image using the controlled light beam from the light source, the first color image and the second color image combine to form an image.

To achieve the above, in one embodiment of the invention, the image processing method for a display device comprises the steps of: receiving an image signal; filtering a first color image signal from the image signal; determining the maximum brightness of the first color image signal; dividing the maximum brightness of an imager by the maximum brightness of the first color image signal to obtain a first color gain value; multiplying the first color image signal by the first color gain value to obtain an first color image-gaining signal; generating a first color control signal according to the first color gain value to control the brightness of a first color light beam from a light source to become a multiple of the original brightness of the first color light beam from the light source and the inverse of the first color gain value; and sending the first color image-gaining signal to the imager and using the controlled light beam from the light source to form a first color image.

To achieve the above, in one embodiment of the invention, the display device comprises: an image-gaining processing module, a light emitting diode array, a modulating module and an imager. The image-gaining processing module, which receives an image signal and filters out a first color image signal and a second color image signal from the image signal, generates a first color gain value depend on the first color image signal and generates a second color gain value depend on the second color image signal. The image-gaining processing module generates a first color image-gaining signal according to the first color gain value and the first color image signal and generates a second color image-gaining signal according to the second color gain value and the second color image signal. The light emitting diode array at least emits a first color light beam and a second color light beam. The modulating module is electrically connected with the light emitting diode array and the image-gaining processing module, wherein the modulating module generates a first color control signal according to the first color gain value to control the brightness of the light beam from the light emitting diode array to become a multiple of the original brightness of the light beam from the light emitting diode array and the inverse of the first color gain value, and generates a second color control signal according to the second color gain value to control the brightness of the light beam from the light emitting diode array to become a multiple of the original brightness of the light beam from the light emitting diode array and the inverse of the second color gain value. The imager is electrically connected with the image-gaining processing module, wherein the imager receives the first color image-gaining signal at the first time slot and produces an first color image using the controlled light beam from the light emitting diode array, and the imager receives the second color image-gaining signal at the second time slot and produces an second color image using the controlled light beam from the light emitting diode array, the first color image and the second color image combine to form an image.

From the above, the display device and the image processing method therefor according to the invention filters each different color image signal (for example, red color image signal, blue color image signal and green color image signal) from the input signal, obtains each color gain value using each different color image signal, multiplies each color image signal by each related color gain value, and adjusts the brightness of each color light beam to become the multiple of the inverse of the related color gain value to enhance the dynamic range of both each color image signal and the display device. In addition, when the light source is a light emitting diode array, the color-filtering module is not necessary in the invention, because the color-filtering module can control the color of the light beam from the light source. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram of a display device in the prior art.

FIG. 2 is a schematic diagram of a display device according to the first embodiment of the invention.

FIG. 3 is a schematic diagram showing an example of calculating the image signal A_{G} and the image signal A_{G}′ in the first embodiment.

FIG. 4 is another schematic diagram of a display device according to the first embodiment of the invention.

FIG. 5 is a flow diagram of an image processing method for a display device according to a second embodiment of the invention.

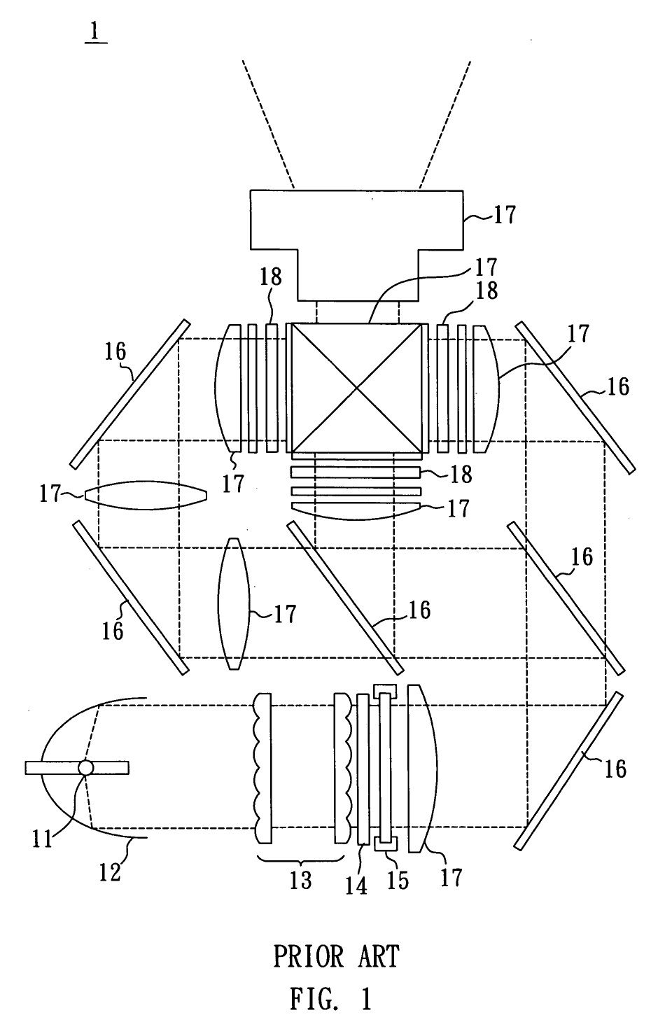

### DETAILED DESCRIPTION OF THE INVENTION

The display devices and the image processing method therefor according to the preferred embodiments of the invention will be described hereinbelow with reference to relevant drawings.

### First Embodiment

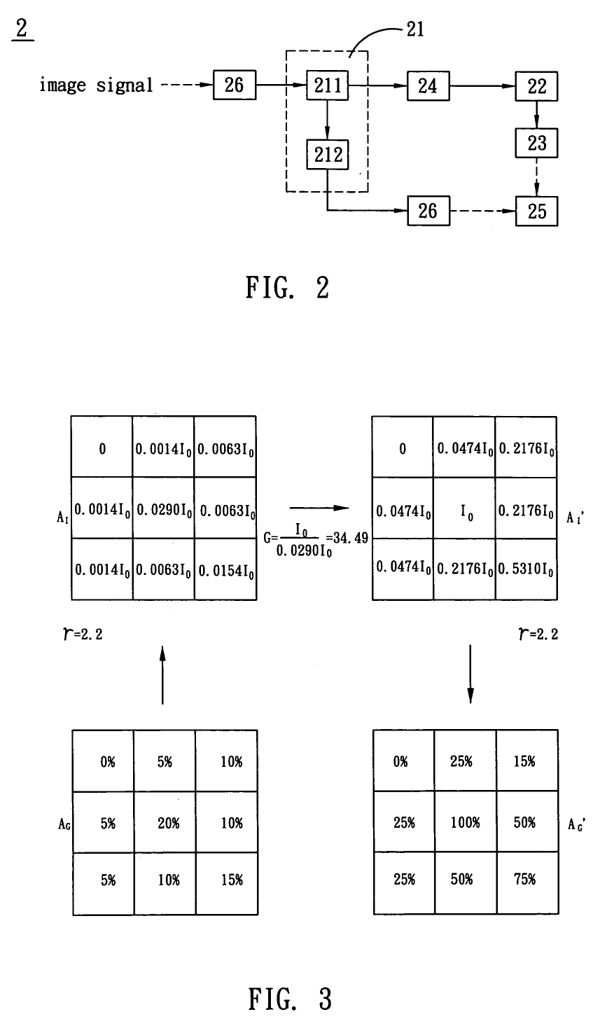

As shown in FIG. 2, the display device 2 according to the first embodiment of the invention includes an image-gaining processing module 21, a light source 22, a color-filtering module 23, a modulating module 24 and an imager 25. The image-gaining processing module 21, which receives an image signal and filters out a first color image signal, a second color image signal and a third color image signal from the image signal. The image-gaining processing module 21 generates a first color gain value (first color gain value, G1) depend on the first color image signal, generates a second color gain value (second color gain value, G2) depend on the second color image signal, and generates a third color gain value (third color gain value, G3) depend on the third color image signal. The image-gaining processing module 21 generates a first color image-gaining signal according to the first color gain value and the first color image signal, generates a second color image-gaining signal according to the second color gain value and the second color image signal, and generates a third color image-gaining signal according to the third color gain value and the third color image signal. The light source 22 emits a light beam. The color-filtering module 23 filters a first color light beam from the light beam at a first time slot, filters a second color light beam from the light beam at a second time slot and filters a third color light beam from the light beam at a third time slot. The modulating module 24 is electrically connected with the light source 22 and the image-gaining processing module 21, wherein the modulating module 24 generates a first color control signal according to the first color gain value to control the brightness of the light beam from the light source 22 to become a multiple of the original brightness of the light beam from the light source and the inverse of the first color gain value, generates a second color control signal according to the second color gain value to control the brightness of the light beam from the light source 22 to become a multiple of the original brightness of the light beam from the light source 22 and the inverse of the second color gain value, and generates a third color control signal according to the third color gain value to control the brightness of the light beam from the light source 22 to become a multiple of the original brightness of the light beam from the light source 22 and the inverse of the third color gain value. The imager 25 is electrically connected with the image-gaining processing module 21, wherein the imager 25 receives the first color image-gaining signal at the first time slot and produces an first color image using the controlled light beam from the light source 22, the imager 25 receives the second color image-gaining signal at the second time slot and produces an second color image using the controlled light beam from the light source 22, and the imager 25 receives the third color image-gaining signal at the third time slot and produces an third color image using the controlled light beam from the light source 22. The first color image, the second color image and the third color image combine to form an image.

In the present embodiment, the first color image signal, the second color image signal, and the third color image signal maybe a red image signal, a blue color image signal, and a green image signal.

In the present embodiment, the image-gaining processing module 21 includes an image gaining module 211 and an image processing module 212, the image gaining module 211 generates the first color gain value using the first color image signal, generates the second color gain value using the second color image signal, and generates the third color gain value using the third color image signal. The image-processing module 212 is electrically connected with the image-gaining module 211. The image processing module 212 generates the first color image-gaining signal according to the first color gain value and the first color image signal, generates the second color image-gaining signal according to the second color gain value and the second color image signal, and generates the third color image-gaining signal according to the third color gain value and the third color image signal.

Furthermore, the image gaining module 211 in the present embodiment generates the gain value using the image signal, which signal is provided by an image source (not shown in the drawing). The image source may be a digital image source or an analog image source. When the image source is an analog image source, the display device 2 may further include an AD converter to convert analog signals to digital signals.

In the present embodiment, the image gaining module 211 determines the maximum gray level of the first color image signal, and divides the maximum gray level of the imager 25 by the maximum gray level of the image signal to obtain the first color gain value. The image gaining module 211 determines the maximum gray level of the second color image signal, and divides the maximum gray level of the imager 25 by the maximum gray level of the image signal to obtain the second color gain value. The image gaining module 211 determines the maximum gray level of the third color image signal, and divides the maximum gray level of the imager 25 by the maximum gray level of the image signal to obtain the third color gain value. Alternatively, the image gaining module 211 may determine the maximum intensity of the first image signal, and divides the maximum intensity of the imager 15 by the maximum intensity of the first color image signal to obtain the first color gain value. The image gaining module 211 may determine the maximum intensity of the second image signal, and divides the maximum intensity of the imager 15 by the maximum intensity of the second color image signal to obtain the second color gain value. The image gaining module 211 may determine the maximum intensity of the third image signal, and divides the maximum intensity of the imager 15 by the maximum intensity of the third color image signal to obtain the third color gain value.

As shown in FIG. 2, the image processing module 212 is electrically connected with the image gaining module 211, and generates an image-gaining signal according to the gain value and the image signal. In other words, the image-gaining signal equals to the multiple of the gain value and the image signal. For example, the first color image-gaining signal equals to the multiple of the first color gain value and the first color image signal.

In the present embodiment, the light source 22 emits light for image production. The light source 22 may be a digital-controlled or analog-controlled light source. For instance, the light source may be a light-emitting diode (LED), a light bulb, a laser (such as a semiconductor laser), an organic LED, an ultrahigh-press mercury lamp, a metal halide lamp, a xenon lamp or a halogen lamp.

In addition, color-filtering module 23 of the present embodiment may be a color wheel. The color wheel comprises a color filter and a motor. The color filter is set on the motor and the motor drives the rotation of the color filter. Herein, the color filter may be a circle glass plates on which at least a red optical film, at least a green optical film and at least a blue optical film coat. The color filter filters the first color light beam from the light source 22 at the first time slot, filters the second color light beam from the light source 22 at the second time slot, and filters the third color light beam from the light source 22 at the third time slot.

As shown in FIG. 2, the display device 2 according to the present embodiment may further include a gray level processing module 26. The gray level processing module 26 converts the image gray level signal into the image intensity signal, or converts the image intensity signal into the image gray level signal.

Furthermore, as shown in FIG. 2, the modulating module 24 is electrically connected with the light source 22 and the image gaining module 211, and generates a first color control signal at the first time slot to control the brightness of the light source 22 according to the first color gain value, wherein the brightness comes out by multiplying the brightness of the original light by the inverse of the gain value. That is, B′=B/G And, the modulating module 24 generates a second color control signal at the second time slot to control the brightness of the light source 22 according to the second color gain value, wherein the brightness comes out by multiplying the brightness of the original light by the inverse of the gain value. And, the modulating module 24 generates a third color control signal at the third time slot to control the brightness of the light source 22 according to the third color gain value, wherein the brightness comes out by multiplying the brightness of the original light by the inverse of the gain value. For example, if the brightness of the original light is B₀, the brightness of the adjusted light is B₀/G1 at the first time slot, the brightness of the adjusted light is B₀/G2 at the second time slot, and the brightness of the adjusted light is B₀/G3 at the third time slot. Here, the modulating module 24 may be a digital modulating module or an analog modulating module.

Moreover, the modulating module 24 may also control the open/close time of the light source 22, so that the brightness B′ of the light emitted by the light source 22 becomes the multiple of the brightness B of the original light and the inverse of the gain value (the first color gain value, the second color gain value, the third color gain value, and so on).

The way of obtaining the first color gain value and the first color image-gaining signal will be described with reference to FIG. 3. First, the first color image gray level signal is converted to the first color image intensity signal. Then, the image gaining module 212 determines the maximum intensity of the first color image intensity signal, that is, 0.0290 I₀. Then, the maximum intensity of the imager 25 (I₀) is divided by the maximum intensity of the first color image intensity signal (0.0290I₀) to obtain the first color gain value G1 (=34.49). Then, the image processing module 212 generates the first color image intensity-gaining signal according to the first color gain value G1 (=34.49) and the first color image intensity signal. Lastly, the first color image intensity-gaining signal is converted to the first color image gray level-gaining signal.

Of course, the way of obtaining the second (third) color gain value and the second (third) color image-gaining signal is same as the above.

As shown in FIG. 3 again, the gray level processing module 26 converts the first color image gray level signal to the first color image intensity signal by the following formula:
A_{I}=I₀×(A_{G})^{γ} (1)
wherein I₀ is the intensity value, A_{G} is the first color image gray level signal, A_{I} is the first color image intensity signal, and γ is an arbitrary number (for example, γ is 2.2 for a CRT display).

Please refer to FIG. 3 again, in the present embodiment, the gray level processing module 26 converts the first color image intensity-gaining signal to the first color image gray level-gaining signal using the following formula:
A_{G}′=(A_{I}′/I₀)^{I/γ} (2)
wherein I₀ is the intensity value, A_{G}′ is the first color image gray level-gaining signal, A₁′ is the first color image intensity-gaining signal and γ is an arbitrary number (for example, γ is 2.2 for a CRT display).

Of course, the gray level processing module 26 may convert the first color image gray level-gaining signal to the first color image intensity-gaining signal or converts the first color image intensity signal to the first color image gray level signal using the above formula (1) or (2).

Please refer to FIG. 2, the imager 25 is electrically connected with the image processing module 212 and the image-gaining processing module 21. The imager 25 receives the first color image-gaining signal at the first tome slot, and produces a first color image using the adjusted light beam from the light source 22 (the brightness of the adjusted light equals to the multiple of the original brightness and the inverse of the gain value). The imager 25 receives the second color image-gaining signal at the second tome slot, and produces a second color image using the adjusted light beam from the light source 22. The imager 25 receives the third color image-gaining signal at the third tome slot, and produces a third color image using the adjusted light beam from the light source 22. The first color image, the second color image and the third color image form the image. This image substantially equals to the image signal.

In the present embodiment, the display device 2 includes, but not limited to, a DLP projector, a transparent type projector, a reflection type projector, or an LCD display.

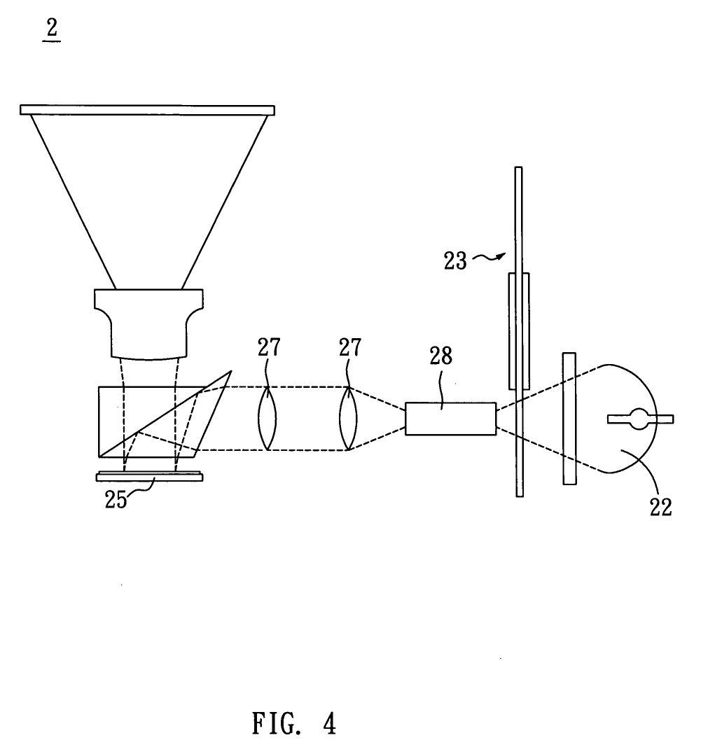

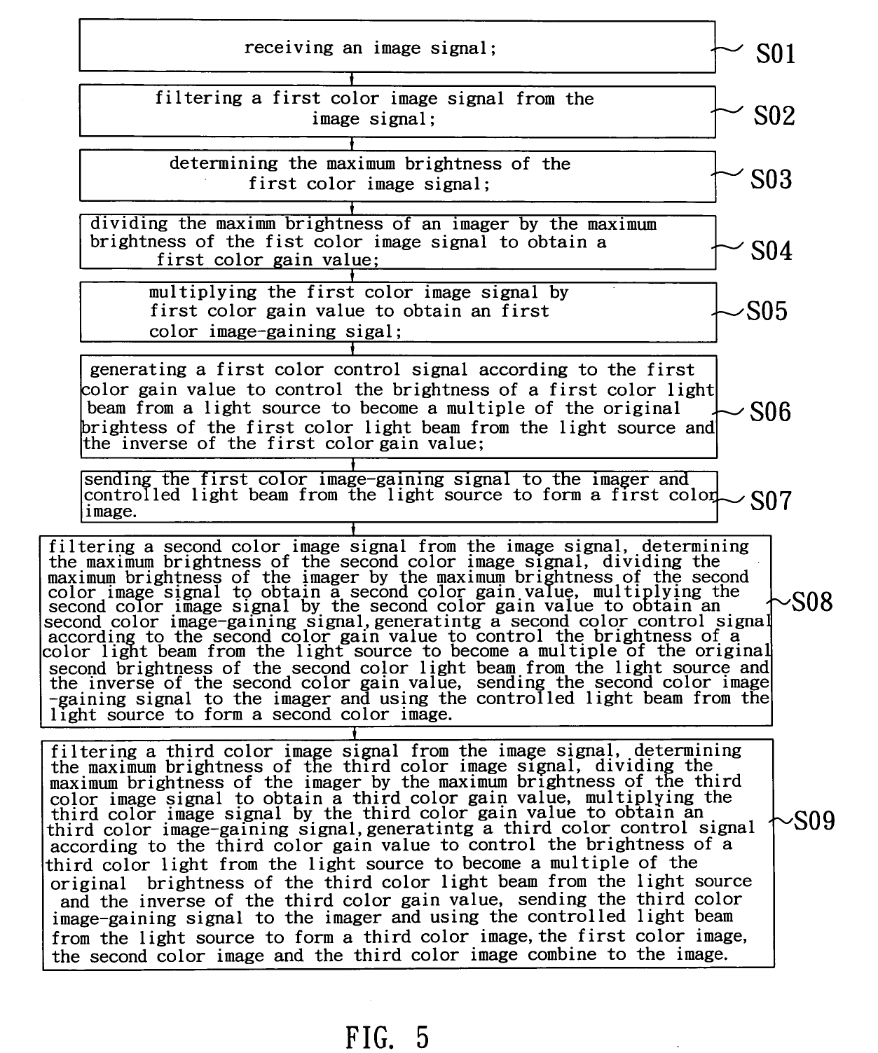

In the present embodiment, the imager 25 includes a display screen when the display device 2 is a projection display device. As shown in FIG. 4, when the display device 2 is a DLP projector, the imager 25 further includes a DMD (digital micro-mirror device). Furthermore, when the display device 2 is a transparent type LCD projector, the imager 25 further includes an LCD light valve. When the display device 2 is a reflection type LCD projector, the imager 25 further includes an LCD reflection panel. As shown in FIG. 5, certainly the display device 2 may be an LCD display, wherein the imager 25 is an LCD panel.

The display device 2 according to the present embodiment further includes a focus unit 27, as shown in FIG. 4. The focus unit 27 focuses the light emitted by the light source 22. Here, the focus unit 27 is provided on the light path. For example, the focus unit 27 can be provided between the light source 22 and the imager 25.

The display device 2 according to the present embodiment further includes an optical guide 28, as shown in FIG. 4. The optical guide 28 is provided on the light path to make uniform the light emitted from the light source 22. The optical guide 28 also has the function of light guiding or changing the direction of light. For example, the optical guide 28 may be a light tunnel.

### Second Embodiment

As shown in FIG. 5, the image processing method for a display device according to the second embodiment of the invention is receiving an image signal (S01), filtering a first color image signal from the image signal (S02), determining the maximum brightness of the first color image signal (S03), dividing the maximum brightness of an imager by the maximum brightness of the first color image signal to obtain a first color gain value (S04), multiplying the first color image signal by the first color gain value to obtain an first color image-gaining signal (S05), generating a first color control signal according to the first color gain value to control the brightness of a first color light beam from a light source to become a multiple of the original brightness of the first color light beam from the light source and the inverse of the first color gain value (S06), and sending the first color image-gaining signal to the imager and using the controlled light beam from the light source to form a first color image (S07).

In addition, as shown in FIG. 5, the image processing method for a display device according to the present embodiment of the invention may further include the step of: filtering a second color image signal from the image signal, determining the maximum brightness of the second color image signal, dividing the maximum brightness of the imager by the maximum brightness of the second color image signal to obtain a second color gain value, multiplying the second color image signal by the second color gain value to obtain an second color image-gaining signal, generating a second color control signal according to the second color gain value to control the brightness of a second color light beam from the light source to become a multiple of the original brightness of the second color light beam from the light source and the inverse of the second color gain value, sending the second color image-gaining signal to the imager and using the controlled light beam from the light source to form a second color image (S08).

In addition, as shown in FIG. 5, the image processing method for a display device according to the present embodiment of the invention may further include the step of: filtering a third color image signal from the image signal, determining the maximum brightness of the third color image signal, dividing the maximum brightness of the imager by the maximum brightness of the third color image signal to obtain a third color gain value, multiplying the third color image signal by the third color gain value to obtain an third color image-gaining signal, generating a third color control signal according to the third color gain value to control the brightness of a third color light from the light source to become a multiple of the original brightness of the third color light beam from the light source and the inverse of the third color gain value, sending the third color image-gaining signal to the imager and using the controlled light beam from the light source to form a third color image, the first color image, the second color image and the third color image combine to the image (S09).

In step S01, receiving the image signal. Herein, the image signal can be represented by gray level or intensity.

In step S02, filtering the first color image signal (for example, red image signal) from the image signal.

In step S03, determining the maximum brightness of the first color image signal. Herein, the image signal is provided by an image source.

In step S04, dividing the maximum brightness of the imager by the maximum brightness of the first color image signal to obtain the first color gain value. Herein, the maximum brightness of the imager can be represented by gray level or intensity.

In step S05, multiplying the first color image signal by the first color gain value to obtain the first color image-gaining signal.

In step S06, generating the first color control signal according to the first color gain value to control the brightness of the first color light beam from the light source to become the multiple of the original brightness of the first color light beam from the light source and the inverse of the gain value. Herein, a modulating module same as the modulating module of the first embodiment may generate the control signal according to the first color gain value to control the brightness of the first color light from the light source to become the multiple of the original brightness of the first color light beam from the light source and the inverse of the first color gain value.

In step S07, sending the first color image-gaining signal to the imager and using the controlled light beam from the light source to form the first color image. In other words, an imager same as the imager of the first embodiment receives the first color image-gaining signal, and produces the first color image using the adjusted light beam from the light source.

In addition, step S08 and step S09 repeats the step from step S01 to step S07, so the detailed descriptions are omitted here for concise purpose.

From step S01 to step S09, the first color image, the second color image and the third color image to form an image. The image substantially equals to the image signal.

### Third Embodiment

The display device 2 according to the first embodiment of the invention includes an image-gaining processing module, a light emitting diode array, a modulating module and an imager. The image-gaining processing module, which receives an image signal and filters out a first color image signal and a second color image signal from the image signal, generates a first color gain value depend on the first color image signal and generates a second color gain value depend on the second color image signal. The image-gaining processing module generates a first color image-gaining signal according to the first color gain value and the first color image signal and generates a second color image-gaining signal according to the second color gain value and the second color image signal. The light emitting diode array at least emits a first color light beam and a second color light beam. The modulating module is electrically connected with the light emitting diode array and the image-gaining processing module, wherein the modulating module generates a first color control signal according to the first color gain value to control the brightness of the light beam from the light emitting diode array to become a multiple of the original brightness of the light beam from the light emitting diode array and the inverse of the first color gain value, and generates a second color control signal according to the second color gain value to control the brightness of the light beam from the light emitting diode array to become a multiple of the original brightness of the light beam from the light emitting diode array and the inverse of the second color gain value. The imager is electrically connected with the image-gaining processing module, wherein the imager receives the first color image-gaining signal at the first time slot and produces an first color image using the controlled light beam from the light emitting diode array, and the imager receives the second color image-gaining signal at the second time slot and produces an second color image using the controlled light beam from the light emitting diode array, the first color image and the second color image combine to form an image.

In the present embodiment, the light-emitting diode array may comprise a plurality of light emitting diodes which emit different color light beam. When the first color image signal is sent to the imager, the light emitting diode array emits the first color light beam to the imager to form the first color image. Furthermore, when the second color image signal is sent to the imager, the light emitting diode array emits the second color light beam to the imager to form the second color image. Herein, the light emitting diode array emits the color light beam according to the color image signals which is sent to the imager.

The features and functions of the other elements are the same to those same elements described previously, so the detailed descriptions are omitted here for concise purpose.

From the above, the display device and the image processing method therefor according to the invention filters each different color image signal (for example, red color image signal, blue color image signal and green color image signal) from the input signal, obtains each color gain value using each different color image signal, multiplies each color image signal by each related color gain value, and adjusts the brightness of each color light beam to become the multiple of the inverse of the related color gain value to enhance the dynamic range of both each color image signal and the display device. In addition, when the light source is a light emitting diode array, the color-filtering module is not necessary in the invention, because the color-filtering module can control the color of the light beam from the light source. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

The description should not be construed in a limiting sense. Any modifications and changes within the spirit and scope of the invention should be included in the appended claims.

What is claimed is:

1. A display device, comprising:
an image-gaining processing module, which receives an image signal and filters out a first color image signal and a second color image signal from the image signal, generates a first color gain value depend on the first color image signal and generates a second color gain value depend on the second color image signal, and generates a first color image-gaining signal according to the first color gain value and the first color image signal and generates a second color image-gaining signal according to the second color gain value and the second color image signal;
a light source emitting a light beam;
a color-filtering module filtering a first color light beam from the light beam at a first time slot and filtering a second color light beam from the light beam at a second time slot;
a modulating module electrically connected with the light source and the image-gaining processing module, wherein the modulating module generates a first color control signal according to the first color gain value to control the brightness of the light beam from the light source to become a multiple of the original brightness of the light beam from the light source and the inverse of the first color gain value, and generates a second color control signal according to the second color gain value to control the brightness of the light beam from the light source to become a multiple of the original brightness of the light beam from the light source and the inverse of the second color gain value; and
an imager electrically connected with the image-gaining processing module, wherein the imager receives the first color image-gaining signal at the first time slot and produces an first color image using the controlled light beam from the light source, and the imager receives the second color image-gaining signal at the second time slot and produces an second color image using the controlled light beam from the light source, the first color image and the second color image combine to form an image.

2. The display device according to claim 1, wherein the image-gaining processing module includes an image gaining module and an image processing module, the image gaining module generates the first color gain value using the first color image signal, and generates the second color gain value using the second color image signal, the image processing module is electrically connected with the image gaining module, and generates the first color image-gaining signal according to the first color gain value and the first color image signal and generates the second color image-gaining signal according to the second color gain value and the second color image signal.

3. The display device according to claim 1, wherein the light source is a light-emitting diode (LED), a light bulb, a laser or an organic LED.

4. The display device according to claim 1, wherein the first color image-gaining signal equals to the first color gain value multiplied by the first color image signal, and the second color image-gaining signal equals to the second color gain value multiplied by the second color image signal.

5. The display device according to claim 1, wherein the imager is an LCD panel.

6. The display device according to claim 1, wherein the display device is of a projection type.

7. The display device according to claim 1, wherein the image-gaining processing module filters out a third color image signal from the image signal, and generates a third color gain value depend on the third color image signal, then generates a third color image-gaining signal according to the third color gain value and the third color image signal, the color-filtering module filters a third color light beam from the light beam at a third time slot, the modulating module generates a third color control signal according to the third color gain value to control the brightness of the light beam from the light source to become a multiple of the original brightness of the light beam from the light source and the inverse of the third color gain value, the imager receives the third color image-gaining signal at the third time slot and produces an third color image using the controlled light beam from the light source, the first color image, the second color image and the third color image combine to form an image.

8. An image processing method for a display device, comprising the steps of:
receiving an image signal;
filtering a first color image signal from the image signal;
determining the maximum brightness of the first color image signal;
dividing the maximum brightness of an imager by the maximum brightness of the first color image signal to obtain a first color gain value;
multiplying the first color image signal by the first color gain value to obtain an first color image-gaining signal;
generating a first color control signal according to the first color gain value to control the brightness of a first color light beam from a light source to become a multiple of the original brightness of the first color light beam from the light source and the inverse of the first color gain value; and
sending the first color image-gaining signal to the imager and using the controlled light beam from the light source to form a first color image.

9. The image processing method for a display device according to claim 8, further comprising the step of:
filtering a second color image signal from the image signal, determining the maximum brightness of the second color image signal, dividing the maximum brightness of the imager by the maximum brightness of the second color image signal to obtain a second color gain value, multiplying the second color image signal by the second color gain value to obtain an second color image-gaining signal, generating a second color control signal according to the second color gain value to control the brightness of a second color light beam from the light source to become a multiple of the original brightness of the second color light beam from the light source and the inverse of the second color gain value, sending the second color image-gaining signal to the imager and using the controlled light beam from the light source to form a second color image.

10. The image processing method for a display device according to claim 9, further comprising the step of:
filtering a third color image signal from the image signal, determining the maximum brightness of the third color image signal, dividing the maximum brightness of the imager by the maximum brightness of the third color image signal to obtain a third color gain value, multiplying the third color image signal by the third color gain value to obtain an third color image-gaining signal, generating a third color control signal according to the third color gain value to control the brightness of a third color light from the light source to become a multiple of the original brightness of the third color light beam from the light source and the inverse of the third color gain value, sending the third color image-gaining signal to the imager and using the controlled light beam from the light source to form a third color image, the first color image, the second color image and the third color image combine to the image.

11. The image processing method for a display device according to claim 8, wherein the light source is a light-emitting diode (LED), a light bulb, a laser or an organic LED.

12. The image processing method for a display device according to claim 8, wherein the display device is of a projection type.

13. The image processing method for a display device according to claim 10, wherein a color-filtering module filters the first color light beam, the second color light beam and the third color light beam from the light beam which the light source emits.

14. A display device, comprising:
an image-gaining processing module, which receives an image signal and filters out a first color image signal and a second color image signal from the image signal, generates a first color gain value depend on the first color image signal and generates a second color gain value depend on the second color image signal, and generates a first color image-gaining signal according to the first color gain value and the first color image signal and generates a second color image-gaining signal according to the second color gain value and the second color image signal;
a light emitting diode array at least emitting a first color light beam and a second color light beam;
a modulating module electrically connected with the light emitting diode array and the image-gaining processing module, wherein the modulating module generates a first color control signal according to the first color gain value to control the brightness of the light beam from the light emitting diode array to become a multiple of the original brightness of the light beam from the light emitting diode array and the inverse of the first color gain value, and generates a second color control signal according to the second color gain value to control the brightness of the light beam from the light emitting diode array to become a multiple of the original brightness of the light beam from the light emitting diode array and the inverse of the second color gain value; and
an imager electrically connected with the image-gaining processing module, wherein the imager receives the first color image-gaining signal at the first time slot and produces an first color image using the controlled light beam from the light emitting diode array, and the imager receives the second color image-gaining signal at the second time slot and produces an second color image using the controlled light beam from the light emitting diode array, the first color image and the second color image combine to form an image.

15. The display device according to claim 14, wherein the image-gaining processing module filters out a third color image signal from the image signal, and generates a third color gain value depend on the third color image signal, then generates a third color image-gaining signal according to the third color gain value and the third color image signal, the color-filtering module filters a third color light beam from the light emitting diode array at a third time slot, the modulating module generates a third color control signal according to the third color gain value to control the brightness of the light beam from the light emitting diode array to become a multiple of the original brightness of the light beam from the light emitting diode array and the inverse of the third color gain value, the imager receives the third color image-gaining signal at the third time slot and produces an third color image using the controlled light beam from the light emitting diode array, the first color image, the second color image and the third color image combine to form the image.
